(19) United States
(12) Patent Application Publication
(10) Pub. No.: US 2026/0343321 A1
(43) Pub. Date: Oct. 29, 2026

(54) MANAGING USAGE OF WIRELESS LINKS IN A MULTI-LINK OPERATION (MLO) MODE

(71) Applicant: HEWLETT PACKARD ENTERPRISE DEVELOPMENT LP, Spring, TX (US)

(72) Inventors: Prateek Patni, San Jose, CA (US); Myung Cheol Kim, San Jose, CA (US)

(21) Appl. No.: 19/188,253

(22) Filed: Apr. 24, 2025

(51) Int. Cl. H04W 28/08; H04W 24/08; H04W 28/10; H04W 88/06

(52) U.S. Cl. CPC H04W 28/0942; H04W 24/08; H04W 28/10; H04W 88/06

(57) ABSTRACT

Examples described herein relate to a method for managing usage of wireless links for a networking device operating in Multi-Link Operation (MLO) mode over a first wireless link and a second wireless link is presented. The method includes the networking device determining a bandwidth difference between the first wireless link and the second wireless link. Further, the networking device determines a first occupancy metric for the first wireless link and a second occupancy metric for the second wireless link, where the first and second metrics indicate the level of busyness of the respective wireless links. Thereafter, the networking device may switch its operation between MLO mode and a limited wireless link operating mode based on the bandwidth difference and occupancy metrics, wherein, in the limited wireless link operating mode, the network device stops communicating over the busier link.

### BACKGROUND

The wireless-fidelity (Wi-Fi) standards, such as the Institute of Electrical and Electronics Engineers (IEEE) 802.11be (also known as Wi-Fi 7), generally promise to significantly boost the speed and stability of wireless connections while offering lower latency and seamlessly managing an increased number of connections compared to the prior Wi-Fi Standards. In particular, IEEE 802.11be introduced a feature - Multi-Link Operation (MLO) that allows devices to simultaneously utilize multiple frequency bands (e.g., 2.4 gigahertz (GHz), 5 GHz, and 6 GHz) to enhance overall performance, reliability, quality of service, efficiency of wireless communication with reduced latency. These features collectively improve the overall user experience and support the growing demands of modern wireless applications.

### BRIEF DESCRIPTION OF THE DRAWINGS

One or more examples in the present disclosure are described in detail with reference to the following Figures. The figures are provided for illustration purposes only and merely depict examples.

FIG. 1 depicts a block diagram of a networked system depicting a networking device in wireless communication with another networking device over a plurality of wireless links.

FIG. 2 depicts a flowchart of an example method for managing the usage of wireless links for a networking device operating in Multi-Link Operation (MLO) mode.

FIG. 3 depicts a flowchart of another example method for managing the usage of wireless links for a networking device operating in MLO mode.

FIG. 4 depicts a flowchart of yet another example method for managing the usage of wireless links for a networking device operating in MLO mode.

FIG. 5 depicts a block diagram of a networking device.

FIG. 6 depicts a block diagram of an example computing system.

The Figures are not exhaustive and do not limit the present disclosure to the precise form disclosed.

### DETAILED DESCRIPTION

The IEEE 802.11be standard, commonly known as Wi-Fi 7, introduces several features designed to enhance wireless communication performance significantly. Among these advancements are faster data rates and the utilization of wider channels, which contribute to the increased capacity and efficiency of the network. One of the most notable new features in Wi-Fi 7 is MLO. MLO allows Wi-Fi client devices such as smartphones, laptops, and other connected devices to simultaneously establish and use multiple connections across different frequency bands (e.g., 2.4 GHz, 5 GHz, and 6 GHz). This capability enables bandwidth aggregation from multiple links, resulting in higher overall throughput and improved network performance.

While the IEEE 802.11be standard and its MLO feature bring significant performance improvements to Wi-Fi networks, they also introduce certain challenges. In particular, while using MLO can be theoretically advantageous, the practical implementation may lead to performance bottlenecks in certain cases, especially when there is a significant disparity in the bandwidth capabilities of the connected wireless links.

For instance, consider a scenario where an enhanced Multi-Link Single Radio (eMLSR) client device is connected to an Access Point (AP) using two wireless links – one from the 6 GHz band (hereinafter referred to as a 6 GHz wireless link) and another from the 2.4 GHz band (hereinafter referred to as a 2.4 GHz wireless link) of the Wi-Fi frequency spectrum. The 6 GHz wireless link operates at a high bandwidth of 320 MHz, whereas the 2.4 GHz wireless link is limited to 20 MHz. The 6 GHz band, although more congested than the 2.4 GHz band, still experiences about 20% channel saturation due to Overlapping Basic Service Set (OBSS) traffic. In particular, when a bidirectional Transmission Control Protocol (TCP BiDi) traffic session is initiated, the MLO mechanism dynamically shifts the data transmission between the 6 GHz wireless link and the 2.4 GHz wireless link. This dynamic switching, while intended to balance the load and improve reliability, inadvertently degrades overall throughput. The constraint of the 20 MHz bandwidth in the 2.4 GHz wireless link becomes a limiting factor, reducing the effective data rate. In contrast, if MLO is disabled, the client device may associate exclusively with the 6 GHz wireless link, benefiting from its higher bandwidth.

Furthermore, the situation can be exacerbated when considering Simultaneous Transmit Receive (STR) Multi-Link Multi-Radio (MLMR) clients. These clients are designed to transmit and receive simultaneously on different frequency bands, such as transmitting on the 6 GHz wireless link while receiving on the 2.4 GHz wireless link. The challenge arises from the inherent limitations of the 2.4 GHz wireless channel, which is not only narrower in bandwidth but also more susceptible to interference from legacy devices and other external factors. This asymmetric operation leads to a significant reduction in throughput for an AP, as the 20 MHz bandwidth of the 2.4 GHz wireless link throttles the data rate. Consequently, the full potential of the 320 MHz 6 GHz wireless link is underutilized, leading to suboptimal network performance.

Additionally, the performance degradation due to MLO can be influenced by the dynamic nature of OBSS traffic, which introduces variability in channel conditions. For instance, the 6 GHz wireless link, although initially less congested, can experience fluctuating levels of saturation, impacting the efficiency of MLO's link-switching algorithm. The algorithm's decision-making process, which aims to optimize link selection, may not always accurately predict the best link under rapidly changing conditions. This misjudgment can lead to frequent and unnecessary switching between the 6 GHz wireless link and the 2.4 GHz wireless link, further disrupting the flow of data and reducing effective throughput. In scenarios where the 6 GHz band is predominantly stable and offers higher bandwidth, a static association without link-switching would provide more consistent and higher data rates.

In accordance with examples of the present disclosure, a method of dynamically managing the usage of wireless links by a multi-link device (MLD) networking device (hereinafter referred to as a networking device) is presented. In particular, in some examples, the networking device may be configured to dynamically manage its wireless link usage based on the bandwidth disparity and the level of busyness of the wireless links configured for MLO mode. The networking device may be configured to discontinue the use of a given wireless link if the other wireless link offers significantly higher bandwidth and the given wireless link is experiencing excessive retries due to poor signal quality or high interference. Such intelligent management of the wireless links can be particularly beneficial in scenarios like the ones described earlier, where an eMLSR client device is connected to the networking device (e.g., an AP) using both 6 GHz and 2.4 GHz wireless links. For example, given that the 6 GHz wireless link operates at a much higher bandwidth (e.g., 320 MHz) compared to the 2.4 GHz wireless link (e.g., 20 MHz), the networking device may selectively use only the 6 GHz wireless link for both transmission and reception.

The proposed method for managing wireless links for a networking device operating in an MLO mode aims to enhance the performance of networking devices by intelligently switching to a limited wireless link operational mode based on real-time assessments of link conditions. The networking device is initially configured to operate in the MLO mode over two wireless links - a first wireless link and a second wireless link. The proposed method entails the networking device determining the bandwidth difference between two wireless links. These links may have distinct bandwidth capacities. For instance, a 6 GHz wireless link may offer a wider bandwidth (e.g., 320 MHz) compared to a 2.4 GHz wireless link (e.g., 20 MHz). As will be understood, the wireless link with higher bandwidth can generally support higher data throughput.

Further, the networking device may evaluate the occupancy of both wireless links. For example, a first occupancy metric is calculated for the first wireless link, and a second occupancy metric is calculated for the second wireless link. These occupancy metrics represent a level of busyness or congestion on each wireless link, which can be affected by factors such as OBSS traffic, interference, and the number of active devices. A higher occupancy metric indicates a more congested or busier link, which may potentially result in lower available throughput if the link selection is not controlled. By continuously monitoring these occupancy metrics, the networking device can dynamically assess current load and traffic conditions of the wireless links, providing a real-time snapshot of network performance.

Based on the bandwidth difference and occupancy metrics, the networking device may decide whether to continue operating in the MLO mode or switch to a limited wireless link operating mode. In scenarios where one wireless link is significantly busier than the other, the networking device may opt to disable communication over the more congested wireless link, thus entering the limited wireless link operating mode. As will be appreciated, this strategic switch helps prevent the performance degradation observed when the device continues to use a heavily saturated link with lower bandwidth. By using a less busy and higher bandwidth wireless link for communication, the networking device can maintain higher throughput and more stable network performance. This adaptive approach ensures that the networking device optimally utilizes available resources, enhancing the overall efficiency and reliability of the wireless network.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit the disclosed examples, instead, the proper scope of the disclosed examples may be defined by the appended claims.

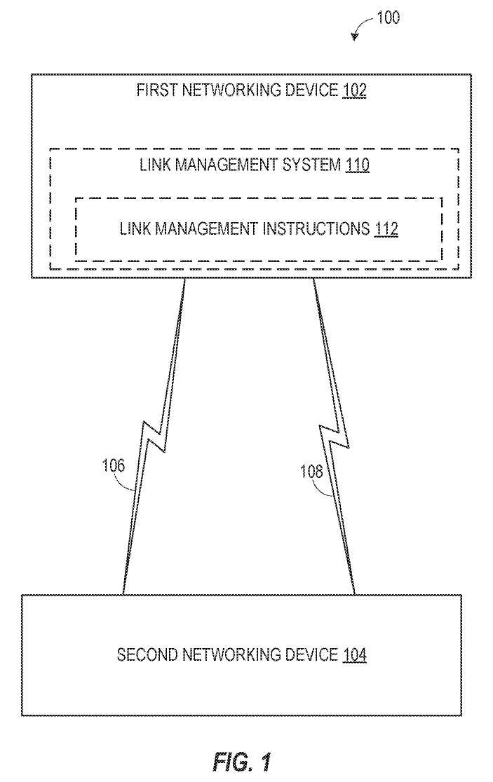

Before describing examples of the disclosed systems and methods in detail, it is useful to describe an example network installation with which these systems and methods might be implemented in various applications. FIG. 1 depicts an example networked system 100 in which various examples presented herein may be implemented. The networked system 100 may be implemented for any setup, for example, in a home setup or an organization, such as a business, educational institution, governmental entity, healthcare facility, or other organization. The networked system 100 may be a small-scale network of devices or a large-scale network of devices. The small-scale network of devices may be a home network, for example. The large-scale network of devices may be an organization, a university, a public utility space (e.g., a mall, an airport, a railway station, a bus station, a stadium, etc.), or an office network hosting a large number of network devices, for example.

The networked system 100 may include several devices that communicate with each other and/or with any external device or system outside the networked system 100. In the example implementation depicted in FIG. 1, the networked system 100 may include a first networking device 102 and a second networking device 104. Although two networking devices are depicted in the example implementation of FIG. 1, the networking system 100 is envisioned to include more than two networking devices within the purview of the present disclosure. Although not shown, in some examples, the networked system 100 may include additional network devices such as a network controller (e.g., a WALN controller), network switches, routers, gateways, and the like to manage and/or provide network connectivity to one or more APs present in the networked system 100.

The first networking device 102 may be a networking device capable of providing wireless connectivity to the second networking device 104 thereby enabling the second networking device 104 to communicate with other electronic devices (not shown in FIG. 1). The first networking device 102 may include a combination of hardware, software, and/or firmware that is configured to provide wireless network connectivity to the client device. In particular, the first networking device 102 may act as a point of access to a local network established in the networked system 100 and/or the external network (not shown) for the client devices. The first networking device 102 may be implemented with one or more radios to help the first networking device 102 communicate with the second networking device 104 and other wireless-capable devices. Each radio of the first networking device 102 may operate on a respective range of radio frequencies, referred to as a Wi-Fi band, for example, the 2.4 GHz Wi-Fi band, the 5 GHz Wi-Fi band, the 6 GHz Wi-Fi band, and so on.

The second networking device 104 may be any electronic device having wireless communication capability. In one example, the second networking device 104 may be a client device that uses wireless connectivity enabled via the first networking device 102 to communicate with other wireless-capable devices. Examples of the second networking device 104 may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, virtual terminals, video game consoles, virtual assistants, Internet-of-Things (IoT) devices, and the like. In some examples, the second networking device 104 may be similar to the first networking device 102.

The first networking device 102 and the second networking device 104 may be multi-link devices (MLDs) that can support multi-link operation (MLO) in accordance with Wi-Fi standards, for example, Wi-Fi 7. MLO allows a Wi-Fi device (such as any of the first networking device 102 and the second networking device 104) to simultaneously use multiple frequency bands or channels for data transmission and reception. The primary goal of MLO is to increase throughput, reduce latency, and enhance the overall reliability and robustness of the Wi-Fi connection. By leveraging multiple links, MLO can dynamically balance the load, switch to the best available link, and mitigate interference, leading to a more efficient and stable network performance. Further, with the MLD enabled, the first networking device 102 can establish and manage multiple links across different frequency bands (e.g., 2.4 GHz, 5 GHz, and 6 GHz) with the second networking device 104, enabling it to take full advantage of MLO. This capability allows the first networking device 102 to offer better performance in terms of speed, latency, and reliability compared to traditional single-link devices.

An MLO-enabled client device, such as the second networking device 104, may connect to the first networking device 102 over one or more wireless links. For illustration purposes, the second networking device 104 is shown connected with the first networking device 102 via a plurality of wireless links 106 and 108. It may be noted that the example implementation of FIG. 1 depicts two wireless links 106 and 108 for illustration purposes. An implementation where the networking devices 102 and 104 operate in the MLO mode over more than two wireless links is also envisioned within the purview of the present disclosure.

By way of example, the wireless links 106 and 108 may belong to a first Wi-Fi frequency band (e.g., the 6 GHz band) and a second Wi-Fi frequency band (e.g., the 2.4 GHz band), respectively. The wireless link 106 that belongs to the 6 GHz band is also referred to as the 6 GHz link, and the wireless link 108 that belongs to the 2.4 GHz band is also referred to as the 2.4 GHz link. The wireless links 106 and 108 may represent a specific channel defined by a range of frequencies within the respective Wi-Fi frequency bands. In particular, the wireless links 106 and 108 may be selected from any of the predefined channels in the respective Wi-Fi frequency bands. In some cases, these wireless links may have distinct bandwidth capacities. In particular, the first wireless link 106 may have a greater bandwidth than the second wireless link 108. For instance, the 6 GHz wireless link may offer a wider bandwidth (e.g., 320 MHz) compared to a 2.4 GHz wireless link (e.g., 20 MHz).

As will be appreciated, the MLO between the first networking device 102 and the second networking device 104 may enhance the overall wireless connectivity performance, however the practical implementation of the MLO may lead to performance bottlenecks in certain cases, especially when there is a significant disparity in the bandwidth capabilities of the connected wireless links if utilization of the wireless links Is not well controlled.

In accordance with examples of the present disclosure, one or both of the networking devices 102 and 104 may be configured to effectively manage the utilization of the wireless links 106 and 108 configured for the MLO operation. In the description hereinafter, for illustration purposes, various examples are described with reference to the networking device 102 configured with a link management system 110 for managing the utilization of the wireless links 106 and 108 configured for the MLO operation. In some examples, the networking device 102 may host the link management system 110 by way of a processing resource executing the link management instructions 112 stored in a machine-readable medium of the first networking device 102. For illustration purposes, the link management system 110 and the link management instructions 112 are represented by the dashed outline as they represent digital entities that may be in the form of data and/or instructions that are executable by a physical processing resource, for example, a processor. By way of executing the link management instructions 112, the link management system 110 may efficiently manage usage of the wireless links 106 and 108 by intelligently switching to a limited wireless link operational mode based on real-time assessments of link conditions.

To aid in effectively utilizing the wireless links 106 and 108 for overall better performance, the networking device 102 may first determine a bandwidth difference between the two wireless links 106 and 108. As previously noted, the wireless links 106 and 108, for example, the 6 GHz wireless link 106 may offer a wider bandwidth of 320 MHz compared to the 2.4 GHz wireless link 108 of 20 MHz. As will be understood, the wireless link with higher bandwidth can generally support higher data throughput.

Further, the networking device 102 may evaluate the occupancy of both wireless links 106 and 108. For example, a first occupancy metric is calculated for the first wireless link, and a second occupancy metric is calculated for the second wireless link. These occupancy metrics represent a level of busyness or congestion on each wireless link 106 and 108, which can be affected by factors such as OBSS traffic, interference, and the number of active devices. A higher occupancy metric indicates a more congested or busier link, which may reduce throughput if the link selection is not controlled. By continuously monitoring these occupancy metrics, the networking device 102 can dynamically assess current load and traffic conditions of the wireless links 106 and 108, providing a real-time snapshot of network performance.

Based on the bandwidth difference and occupancy metrics, the networking device 102 may decide whether to continue operating in the MLO mode or switch to a limited wireless link operating mode. In scenarios where one wireless link is significantly busier than the other, the networking device may opt to disable communication over the more congested wireless link, thus entering the limited wireless link operating mode. As will be appreciated, this strategic switch helps prevent the performance degradation observed when the device continues to use a heavily saturated link with lower bandwidth. By using a less busy and higher bandwidth wireless link for communication, the networking device 102 can maintain higher throughput and more stable network performance.

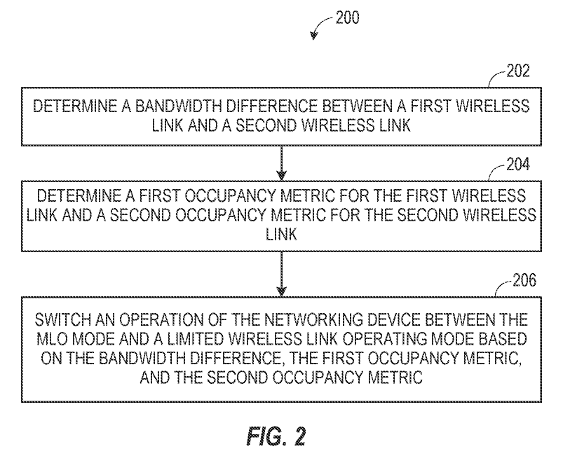

Additional details about managing the usage of wireless links 106 and 108 are described in conjunction with FIGS. 2-4.

Turning now to FIGS. 2-4, flowcharts of example methods for managing the usage of wireless links are presented. The steps shown in FIGS. 2-4 may be performed by any suitable device, such as the networking devices 102 of FIG. 1. In some examples, the suitable device may include a processing resource suitable for the retrieval and execution of instructions stored in a machine-readable storage medium. As an alternative or in addition to retrieving and executing instructions, the processing resource may include one or more electronic circuits that include electronic components for performing the functionality of one or more instructions, such as an FPGA, ASIC, or other electronic circuits. Further, the flow charts shown in FIGS. 2-4 includes several steps in a particular order. However, the order of steps shown in the respective flowcharts should not be construed as the only order for the steps. The steps may be performed at any time in any order. Additionally, the steps may be repeated or omitted as needed.

FIG. 2 describes a method 200 for managing the usage of wireless links for a networking device operating in MLO mode. The method 200 may be performed by any suitable device, such as the networking device 102 of FIG. 1. As described in conjunction with FIG. 1, the networking device 102 may be configured to operate in the MLO mode over a first wireless link and a second wireless link. The first wireless link may have a greater bandwidth than the second wireless link. In an example implementation, the first wireless link may be a 320 MHz bandwidth channel in the 6 GHz band, and the second wireless link may be a 20 MHz bandwidth channel in the 2.4 GHz band.

At step 202, the networking device may determine a bandwidth difference between the first wireless link and the second wireless link. This step is useful in understanding the capacity each wireless link can contribute to overall network performance. The networking device may retrieve, from a link configuration of the wireless links, and/or measure the channel width of each wireless link. The networking device may then use these channel widths to compute the bandwidth difference, effectively determining the disparity in data throughput capabilities between the two links. In some examples, the bandwidth difference calculation involves straightforward measurement of the channel widths without considering modulation schemes or coding rates. For example, in the present implementation with the first channel of 320 MHz and the second channel of 20 MHz bandwidths, the bandwidth difference is 300 MHz. By focusing solely on the channel widths, the networking device simplifies the assessment process. A significant bandwidth difference suggests that one link can handle much more data than the other.

In some examples, this step may also entail continuous monitoring and updating the bandwidth difference to account for dynamic changes in the network environment. Factors such as interference from nearby devices, regulatory changes, or even user settings can alter the effective bandwidth of each link. Therefore, in some examples, the networking device may employ algorithms capable of real-time assessment to ensure that the bandwidth difference reflects the current state of the network. For instance, if a neighboring network starts using part of the spectrum that overlaps with the 6 GHz link (i.e., the first wireless link), the effective bandwidth of this link might decrease. This real-time capability ensures that the device can respond promptly to any changes, maintaining optimal performance by dynamically adjusting its operation based on the most accurate and up-to-date information.

Further, at step 204, the networking device may determine a first occupancy metric for the first wireless link and a second occupancy metric for the second wireless link. In particular, the first occupancy metric and the second occupancy metric respectively indicate a level of busyness of the first wireless link and the second wireless link. These occupancy metrics are useful for understanding the level of busyness or congestion each link experiences. In one example, the occupancy metrics may be any of the retry percentage or the wireless link busy percentage. In certain other examples, the occupancy metrics may be derived from one or both of the retry percentage and the wireless link busy percentage.

The retry percentage may be represented as a proportion of data packets that need to be retransmitted due to issues, such as, but not limited to, collisions or errors, reflecting the link's reliability and current load. For example, a high retry percentage may suggest a congested link with frequent collisions, which can severely impact throughput and increase latency.

The wireless link busy percentage may be a proportion of time the wireless link is actively engaged in data transmission or reception. This wireless link busy percentage may provide an insight into how occupied the link is, considering both successful transmissions and those impacted by interference. For instance, a high busy percentage indicates that the link is frequently used, which could be due to high traffic demand or external interference sources, such as, but not limited to, microwave ovens or Bluetooth devices. By combining these two parameters, the networking device can form a comprehensive view of each wireless link's operational state. For example, a high busy percentage coupled with a low retry rate may indicate an efficiently used but heavily utilized link, whereas a high busy percentage with a high retry rate signals congestion and potential performance degradation.

Accurate determination of these occupancy metrics may entail continuous monitoring of the wireless channels. In some examples, the networking device may implement advanced algorithms to track and record these metrics in real-time, ensuring that the measurements reflect current link conditions. For example, the networking device might use a sliding window algorithm to average the retry rates and busy percentages over a specific period to smooth out transient spikes and provide more stable metric values. Such real-time data collection may be useful in making informed decisions about link management. By understanding the occupancy levels, the networking device can identify which wireless link is more congested and thus less favorable for ongoing communication, guiding the decision-making process for optimal link usage.

Furthermore, at step 206, the networking device may switch the operation of the networking device between the MLO mode and a limited wireless link operating mode based on the bandwidth difference, the first occupancy metric, and the second occupancy metric. In particular, at this step, the networking device may decide whether to continue operating in MLO mode over the first and the second wireless link or switch to a limited wireless link operating mode. Such a dynamic switching between the operating modes may improve network performance by avoiding the pitfalls of using a congested link with lower bandwidth. If the occupancy metrics indicate that one link is significantly busier than the other, and the bandwidth difference shows a substantial disparity in capacity, the networking device may switch to the limited wireless link mode. In this mode, the networking device stops communicating over the busier, less efficient link and relies solely on the higher bandwidth, less congested link.

As will be appreciated, this switching mechanism is designed to prevent performance degradation caused by overutilizing a heavily loaded link. For instance, if the 2.4 GHz link has a high busy percentage and a high retry rate, while the 6 GHz link is relatively free, the device will cease communication over the 2.4 GHz link. This approach ensures that the device can maintain higher throughput and lower latency by leveraging the more capable link.

In some examples, the decision to switch between these modes is not static; the networking device may continually reassess the network conditions (e.g., monitoring of the occupancy metrics) to determine if reverting to the MLO mode would be beneficial, allowing for a dynamic and adaptive network management strategy. To enable such dynamic switching, the networking device may implement algorithms capable of real-time analysis and decision-making based on the bandwidth capabilities and occupancy metrics to make the most informed decision, ensuring that the network can adapt to changing conditions and maintain optimal performance. For example, if the 6 GHz link suddenly becomes congested due to an influx of new devices, the networking device might reassess the occupancy metrics and bandwidth difference to determine whether re-enabling the 2.4 GHz link could provide a better overall performance. By intelligently managing the use of these wireless links, the networking device enhances user experience, reduces latency, and maximizes data throughput, ultimately achieving a more efficient and reliable wireless network.

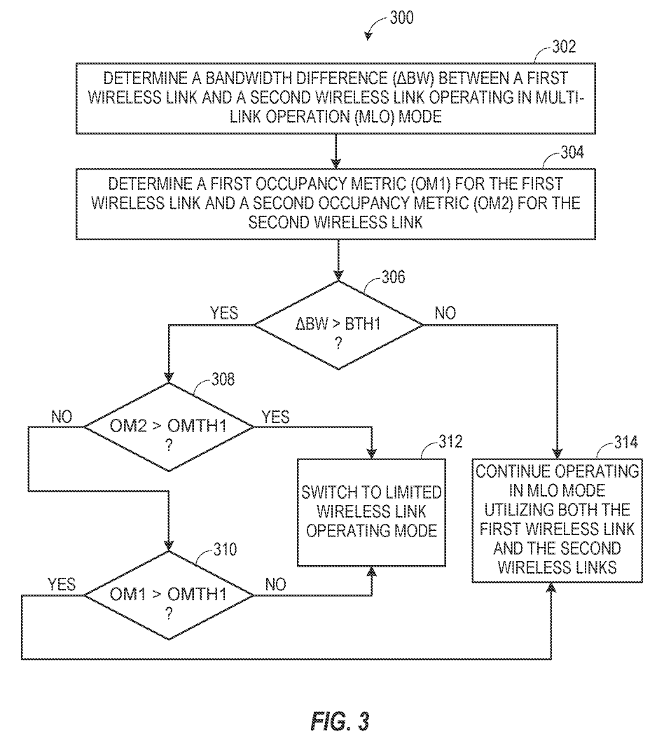

Referring now to FIG. 3, a method 300 for managing the usage of wireless links for a networking device operating in MLO mode is presented. The method 300 may be performed by any suitable device, such as the networking device 102 of FIG. 1. Also, certain steps shown in the flowchart of method 300 (e.g., steps 302 and 304 of method 300) may be similar to those described in FIG. 2 (e.g., steps 202 and 204 of method 200), certain details of which are not repeated herein for brevity. To set a context for FIG. 3, as described in conjunction with FIG. 1, the networking device 102 may be configured to operate in the MLO mode over a first wireless link and a second wireless link. In particular, the first wireless link may have a greater bandwidth than the second wireless link. In an example implementation, the first wireless link may be a 320 MHz bandwidth channel in the 6 GHz band, and the second wireless link may be a 20 MHz bandwidth channel in the 2.4 GHz band. In this context, the first wireless link and the second wireless link are also respectively referred to as the 6 GHz link and the 2.4 GHz link.

At step 302, the networking device may determine a bandwidth difference (ΔBW) between the first wireless link and the second wireless link. Further, at step 304, the networking device may determine a first occupancy metric (OM1) for the first wireless link and a second occupancy metric (OM2) for the second wireless link. The first occupancy metric and the second occupancy metric are hereinafter collectively referred to as occupancy metrics. In particular, the first occupancy metric and the second occupancy metric respectively indicate a level of busyness of the first wireless link and the second wireless link. Additional details of steps 302 and 304 are described in conjunction with steps 202 and 302, respectively, of FIG. 2.

After the bandwidth difference and the occupancy metrics are determined, the networking device may decide whether to continue operating in MLO mode over the first and the second wireless link or switch to a limited wireless link operating mode. In some examples, to make an accurate decision on the link switching, the networking device may perform a series of checks, allowing the networking device to dynamically configure its operation mode based on real-time assessments of link congestion and bandwidth differences.

In some examples, at step 306, the networking device may perform a check to determine whether the bandwidth difference between the first wireless link and the second wireless link is greater than a first bandwidth threshold (BTH1) (i.e., check if ΔBW > BTH1). This first bandwidth threshold is a value that signifies a substantial disparity in the data throughput capabilities of the two links. The networking device may compare the bandwidth difference determined at step 302 with the first bandwidth threshold to assess whether the bandwidth difference between the first wireless link and the second wireless link is greater than the first bandwidth threshold. For example, for the first wireless link of bandwidth 320 MHz and the second wireless link of bandwidth 20 MHz, the bandwidth difference at step 302 may be determined as 300 MHz. In an example implementation, if the first bandwidth threshold is set at 280 MHz, the calculated bandwidth difference of 300 MHz exceeds this threshold, indicating a significant bandwidth disparity between the two links. This significant difference indicates that the first link (i.e., the 6 GHz link) can handle much more data than the second link (i.e., the 2.4 GHz link).

At step 306, if it is determined that the bandwidth difference is not greater than the first bandwidth threshold (i.e., ΔBW ≤ BTH1), in one example, the networking device may continue operating in the MLO mode as indicated at step 314. However, at step 312, if it is determined that the bandwidth difference between the first wireless link and the second wireless link is greater than the first bandwidth threshold (i.e., ΔBW > BTH1), the networking device may evaluate if there is a substantial difference in link capacities, making it worthwhile to potentially limit operations to the more capable link. For example, on determining that the bandwidth difference is greater than the first bandwidth threshold, the networking device may perform an additional check at step 308.

At step 308, the networking device may perform a check to determine whether the second occupancy metric (associated with the second wireless link) exceeds a predefined first occupancy threshold (OMTH1) (i.e., check if OM2 > OMTH1). The second occupancy metric (OM2) represents the level of busyness or congestion of the second wireless link, calculated from parameters such as retry percentage and wireless link busy percentage. In particular, upon entering the decision box at step 308, the networking device may compare the current value of the second occupancy metric with the predefined first occupancy threshold. This threshold signifies excessive congestion or high utilization of the second wireless link. For instance, if the first occupancy threshold is set at 80%, and the second occupancy metric indicates 85%, this suggests that the second link is highly congested. Consider a scenario where the 2.4 GHz link has an occupancy metric of 85% due to high interference and numerous retransmissions, while the 6 GHz link is less busy. In such a case, the 2.4 GHz link exceeds the threshold, indicating it is overburdened and less efficient for communication.

At step 308, if it is determined that the second occupancy metric exceeds the predefined first occupancy threshold (i.e., OM2 > OMTH1), the networking device, at step 314, may switch its operating mode to the limited wireless link operating mode. In this limited wireless link operating mode, the networking device stops using the second wireless link for both transmission and reception and relies solely on the first wireless link, which is less congested. In particular, in the limited wireless link operating mode, the networking device may configure the first wireless link for both transmission and reception of data traffic by the networking device. This decision helps maintain higher throughput and lower latency by avoiding the use of an overburdened link.

On the contrary, if it is determined that the second occupancy metric does not exceed the predefined first occupancy threshold (i.e., OM2 ≤ OMTH1), at step 310, the networking device may perform another check to evaluate whether the first occupancy metric exceeds the first occupancy threshold (i.e., check if OM1 > OMTH1). This check ensures that the decision to switch modes considers the activity levels of both links. At step 310, if it is determined that the first occupancy metric does not exceed the first occupancy threshold (i.e., OM1 ≤ OMTH1), the networking device understands that neither link is heavily congested. In particular, in one example, if both the occupancy metrics do not exceed this first occupancy threshold, it indicates that neither wireless link is experiencing excessive congestion. For instance, if the first occupancy threshold is set at 80%, both occupancy metrics need to be below this value to trigger the mode switch. Consider a scenario where the occupancy metrics for the 6 GHz and 2.4 GHz links are 60% and 50%, respectively. These values are below the 80% threshold, suggesting that neither link is heavily congested. This situation indicates that the overall network environment is relatively stable and underutilized.

Accordingly, at step 310, if it is determined that the first occupancy metric does not exceed the first occupancy threshold (i.e., OM1 ≤ OMTH1), the networking device, at step 314, may switch to the limited wireless link operating mode. Similar to the action taken in the check at step 308, the networking device ceases communication over the second wireless link and relies exclusively on the first wireless link. This decision is based on the rationale that consolidating communication to one link can simplify network management and potentially enhance performance by leveraging the most stable and efficient link available. For instance, even though both links are below the threshold, the networking device might find that focusing solely on the 6 GHz link (with its higher bandwidth) ensures a more streamlined and efficient use of network resources.

On the other hand, at step 310, if it is determined that the first occupancy metric exceeds the first occupancy threshold (i.e., OM1 > OMTH1), the networking device may maintain its operation in the MLO mode and continue using both the first and second wireless links. This decision allows the networking device to balance the load across both links, utilizing the less congested 2.4 GHz link to alleviate some of the demand on the 6 GHz link. This approach maintains higher overall network performance and ensures efficient use of available resources.

In summary, the sequence of decisions (e.g., ones at check boxes 306, 308, and 310) helps the networking device in dynamically configuring its operation mode based on real-time assessments of link congestion and bandwidth differences. The checks ensure that the device switches to the limited wireless link operating mode when there is a substantial bandwidth difference and significant congestion on one link. Additionally, maintaining the MLO mode is considered when it can optimize overall network performance. The proposed networking device optimizes network performance by intelligently managing link usage based on these conditions, ensuring higher throughput and reduced latency. This adaptive approach allows the networking device to respond dynamically to changing network conditions, maintaining efficient and reliable wireless communication.

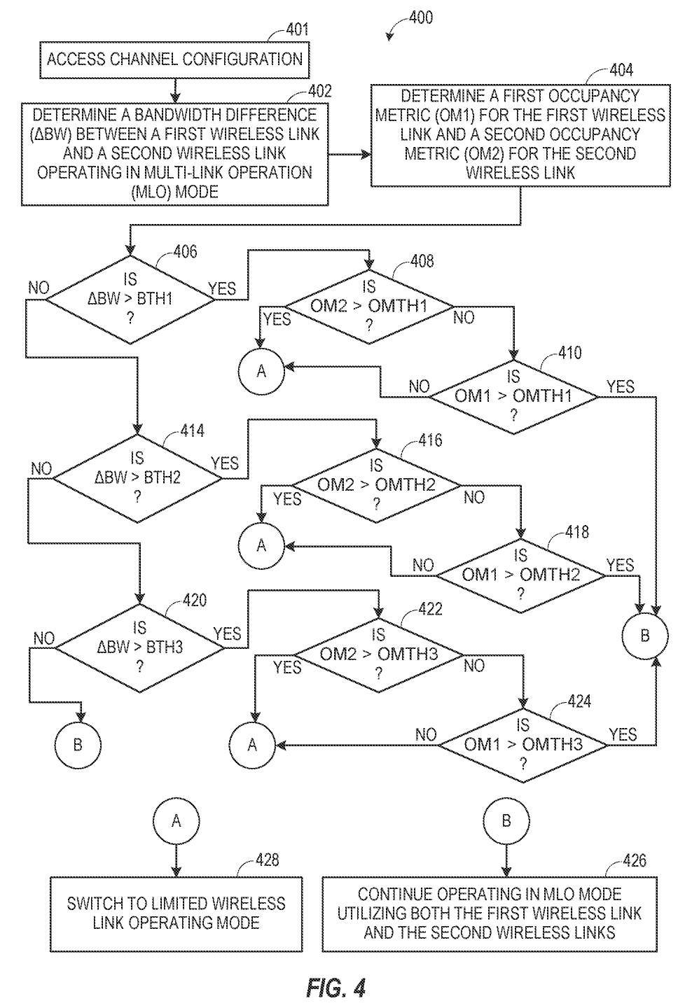

Referring now to FIG. 4, a method 400 for managing the usage of wireless links for a networking device operating in MLO mode is presented. The method 400 may be performed by any suitable device, such as the networking device 102 of FIG. 1, and is an example representative of the methods 200 and 300 described earlier. In particular, the method 400 represents an example technique where the networking device may perform multiple levels of checks on the bandwidth difference and the occupancy metrics to accommodate for varying bandwidth differences and occupancy levels. Also, certain steps shown in the flowchart of method 400 may be similar to those described in earlier methods 200 and 300, certain details of which are not repeated herein for brevity.

At step 401, the networking device may access a channel configuration to obtain channel specifications of one or more wireless links configured for the MLO mode. In one example, the channel specifications may include information about the bandwidth of each of the wireless links configured for the MLO mode. For the example implementation of FIG. 1, the networking device may be configured to operate in the MLO mode over a first wireless link (e.g., the 6 GHz link) and a second wireless link (e.g., the 2.4 GHz link), having bandwidths of 320 MHz and 20 MHz, respectively. In particular, the first wireless link may have a greater bandwidth than the second wireless link.

Further, at step 402, the networking device may determine a bandwidth difference (ΔBW) between the first wireless link and the second wireless link. For example, for the first wireless link of bandwidth 320 MHz and the second wireless link of bandwidth 20 MHz, the bandwidth difference at step 402 may be determined as 300 MHz. Further, at step 404, the networking device may determine a first occupancy metric (OM1) for the first wireless link and a second occupancy metric (OM2) for the second wireless link. In particular, the first occupancy metric and the second occupancy metric respectively indicate a level of busyness of the first wireless link and the second wireless link. After the bandwidth difference and the occupancy metrics are determined, the networking device may decide whether to continue operating in MLO mode over the first and the second wireless link or switch to a limited wireless link operating mode. In some examples, to make an accurate decision on the link switching, the networking device may perform a series of checks, allowing the networking device to dynamically configure its operation mode based on real-time assessments of link congestion and bandwidth differences.

In some examples, at step 406, the networking device may perform a check to determine whether the bandwidth difference between the first wireless link and the second wireless link is greater than a first bandwidth threshold (BTH1) (i.e., check if ΔBW > BTH1). This first bandwidth threshold is a value (e.g., 280 MHz) that signifies a substantial disparity in the data throughput capabilities of the two links. At step 406, if it is determined that the bandwidth difference between the first wireless link and the second wireless link is smaller than or equal to the first bandwidth threshold (i.e., ΔBW ≤ BTH1), in one example, the networking device may perform another check at step 414 (described later). However, at step 406, if it is determined that the bandwidth difference between the first wireless link and the second wireless link is greater than the first bandwidth threshold (i.e., ΔBW > BTH1), the networking device may perform an additional check at step 408.

At step 408, the networking device may determine whether the second occupancy metric exceeds a first occupancy threshold (OMTH1) (i.e., check if OM2 > OMTH1). In particular, upon entering the decision box at step 408, the networking device may compare the current value of the second occupancy metric with the predefined first occupancy threshold. This threshold signifies excessive congestion or high utilization of the second wireless link. For instance, if the first occupancy threshold is set at 80%, and in a scenario where the 2.4 GHz link has an occupancy metric of 85% due to high interference and numerous retransmissions, while the 6 GHz link is less busy. In such a case, the 2.4 GHz link exceeds the first occupancy threshold, indicating it is overburdened and less efficient for communication. At step 408, if it is determined that the second occupancy metric exceeds the predefined first occupancy threshold (i.e., OM2 > OMTH1), the networking device may switch its operating mode to the limited wireless link operating mode, wherein the networking device stops using the second wireless link for both transmission and reception and relies solely on the first wireless link, which is less congested.

On the contrary, at step 408, if it is determined that the second occupancy metric does not exceed the predefined first occupancy threshold (i.e., OM2 ≤ OMTH1), at step 410, the networking device may perform another check to evaluate whether the first occupancy metric exceeds the first occupancy threshold (i.e., check if OM1 > OMTH1). At step 410, if it is determined that the first occupancy metric does not exceed the first occupancy threshold (i.e., OM1 ≤ OMTH1), the networking device understands that neither link is heavily congested. Consider a scenario where the occupancy metrics for the 6 GHz and 2.4 GHz links are 60% and 50%, respectively. These values are below the 80% threshold, suggesting that neither link is heavily congested. This situation indicates that the overall network environment is relatively stable and underutilized. Accordingly, at step 410, if it is determined that the first occupancy metric also does not exceed the first occupancy threshold, the networking device may switch to the limited wireless link operating mode at step 428. In particular, in the limited wireless link operating mode, the networking device may configure the first wireless link for both transmission and reception of data traffic by the networking device.

On the other hand, at step 410, if it is determined that the first occupancy metric exceeds the first occupancy threshold (OM1 > OMTH1), the networking device, at step 426, may maintain its operation in the MLO mode and continue using both the first and second wireless links.

Referring now to step 414, which is executed when the bandwidth difference is smaller than or equal to the first bandwidth threshold. In particular, at step 414, the networking device may perform another check to determine whether the bandwidth difference exceeds a second bandwidth threshold (BTH2) (i.e., check if ΔBW > BTH2). This second bandwidth threshold may be set to a value (e.g., 200 MHz) smaller than the first bandwidth threshold. This second bandwidth threshold may signify a lower bandwidth disparity compared to the first bandwidth threshold. At step 414, if it is determined that the bandwidth difference does not exceed the second bandwidth threshold (i.e., ΔBW ≤ BTH1), in one example, the networking device may perform another check at step 420 (described later). However, at step 414, if it is determined that the bandwidth difference is greater than the second bandwidth threshold (i.e., ΔBW > BTH1), the networking device may perform an additional check at step 416.

At step 416, the networking device may determine whether the second occupancy metric exceeds a second occupancy threshold (OMTH2) (i.e., check if OM2 > OMTH2). In particular, upon entering the decision box at step 416, the networking device may compare the current value of the second occupancy metric with the second occupancy threshold. This second occupancy threshold may be set to a value (e.g., 60%) that is smaller than the first occupancy threshold. For instance, if the second occupancy threshold is set at 60%, and in a scenario where the 2.4 GHz link has an occupancy metric of 70% due to high interference and numerous retransmissions, the 2.4 GHz link exceeds the first occupancy threshold, indicating it is overburdened and less efficient for communication. At step 416, if it is determined that the second occupancy metric exceeds the second occupancy threshold (i.e., OM2 > OMTH2), the networking device, at step 428, may switch its operating mode to the limited wireless link operating mode. On the contrary, at step 416, if it is determined that the second occupancy metric does not exceed the second occupancy threshold (i.e., OM2 ≤ OMTH2), the networking device, at step 418, may perform another check to evaluate whether the first occupancy metric exceeds the second occupancy threshold (i.e., check if OM1 > OMTH2).

At step 418, if it is determined that the first occupancy metric does not exceed the second occupancy threshold (i.e., OM1 ≤ OMTH2), the networking device understands that neither link is heavily congested. Consider a scenario where the occupancy metrics for the 6 GHz and 2.4 GHz links are 40% and 30%, respectively. These values are below the 60% threshold, suggesting that neither link is heavily congested. This situation indicates that the overall network environment is relatively stable and underutilized. Accordingly, at step 418, if it is determined that the first occupancy metric also does not exceed the second occupancy threshold, the networking device, at step 428, may switch to the limited wireless link operating mode. On the other hand, at step 418, if it is determined that the first occupancy metric exceeds the second occupancy threshold (i.e., OM1 > OMTH2), the networking device, at step 426, may maintain its operation in the MLO mode and continue using both the first and second wireless links.

Referring now to step 420, which is executed when the bandwidth difference is not greater than the second bandwidth threshold. In particular, at step 420, the networking device may perform another check to determine whether the bandwidth difference is greater than a third bandwidth threshold (BTH3) (i.e., check if ΔBW > BTH3). This third bandwidth threshold may be set to a value (e.g., 120 MHz) that is smaller than the second bandwidth threshold. This third bandwidth threshold may signify even lower bandwidth disparity compared to the second bandwidth threshold. At step 420, if it is determined that the bandwidth difference does not exceed the third bandwidth threshold (i.e., ΔBW ≤ BTH3), in one example, the networking device, at step 426, may continue operating in the MLO mode. However, at step 420, if it is determined that the bandwidth difference is greater than the third bandwidth threshold (i.e., ΔBW > BTH3), the networking device may perform an additional check at step 422.

At step 422, the networking device may determine whether the second occupancy metric exceeds a third occupancy threshold (OMTH3) (i.e., check if OM2 > OMTH3). This third occupancy threshold may be set to a value (e.g., 40%) that is smaller than the first occupancy threshold. For instance, if the third occupancy threshold is set at 40%, and in a scenario where the 2.4 GHz link has an occupancy metric of 50% due to high interference and numerous retransmissions, the 2.4 GHz link exceeds the first occupancy threshold, indicating it is overburdened and less efficient for communication. At step 422, if it is determined that the second occupancy metric exceeds the third occupancy threshold (i.e., OM2 > OMTH3), the networking device, at step 428, may switch its operating mode to the limited wireless link operating mode. On the contrary, at step 416, if it is determined that the second occupancy metric does not exceed the third occupancy threshold (i.e., OM2 ≤ OMTH3), the networking device, at step 424, may perform another check to evaluate whether the first occupancy metric exceeds the second occupancy threshold (i.e., check if OM1 > OMTH3).

At step 424, if it is determined that the first occupancy metric does not the third occupancy threshold (OM1 ≤ OMTH3), the networking device understands that neither link is heavily congested. Consider a scenario where the occupancy metrics for the 6 GHz and 2.4 GHz links are 30% and 35%, respectively. These values are below the 40% threshold, suggesting that neither link is heavily congested. Accordingly, at step 424, if it is determined that the first occupancy metric is also smaller than or equal to the third occupancy threshold, the networking device, at step 428, may switch to the limited wireless link operating mode. On the other hand, at step 424, if it is determined that the first occupancy metric exceeds the third occupancy threshold (i.e., OM1 > OMTH3), the networking device may maintain its operation in the MLO mode and continue using both the first and second wireless links.

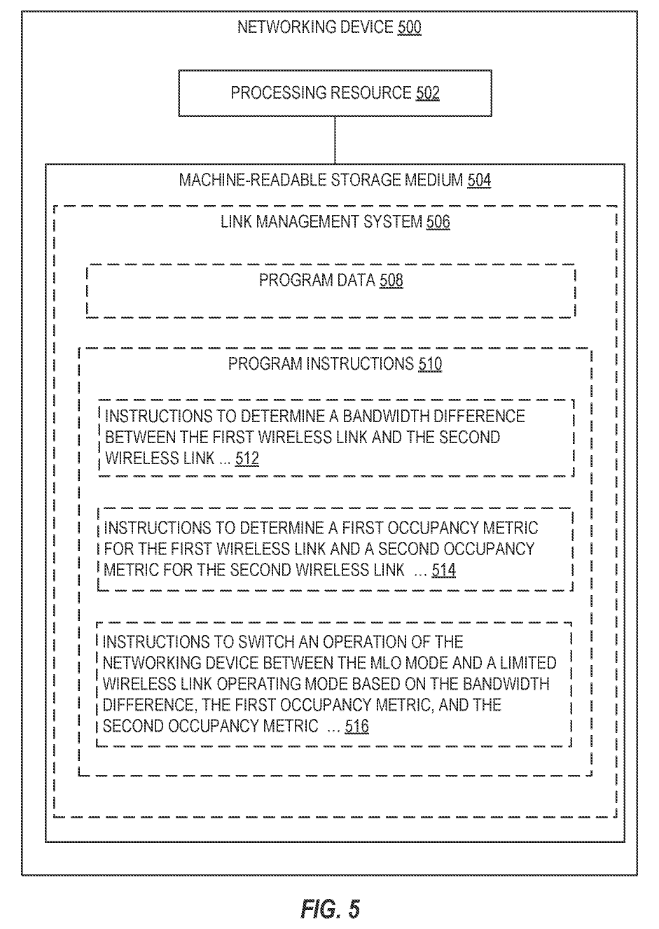

Referring to FIG. 5, a block diagram of an example networking device 500 is presented. The networking device 500 of FIG. 5 may be an example representative of the networking device 102 or 104 of FIG. 1. The networking device 500 is configured with a link management system 506 to manage the usage of wireless links (e.g., the wireless links 106 and 108) in MLO mode. For illustration purposes, the link management system 506 and items inside the link management system 506 are represented by the dashed outline as they represent digital entities that may be in the form of data and/or instructions that are executable by a physical processing resource, for example, the processing resource 502. The networking device 500 may include a processing resource 502 and/or a machine-readable storage medium 504 for the networking device 500 to execute several operations as will be described in greater detail below.

The processing resource 502 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 504, or combinations thereof. In one example, the processing resource 502 may fetch, decode, and execute the instructions stored in the machine-readable storage medium 504 to aid in managing the usage of wireless links in MLO mode. As an alternative or in addition to executing the instructions, the processing resource 502 may include at least one integrated circuit (IC), control logic, electronic circuits, or combinations thereof that include a number of electronic components for performing the functionalities intended to be performed by the networking device 500.

The machine-readable storage medium 504 may be non-transitory and is alternatively referred to as a non-transitory machine-readable storage medium that does not encompass transitory propagating signals. The machine-readable storage medium 504 may be any electronic, magnetic, optical, or another type of storage device that may store data and/or executable instructions. Examples of the machine-readable storage medium 504 may include Randon Access Memory (RAM), Non-volatile random-access memory (NVRAM), Electrically Erasable Programmable Read-Only Memory (EEPROM), a storage drive (e.g., Solid-State Drive or Hard Disk Drive), a flash memory device, and the like. The machine-readable storage medium 504 may be encoded with the link management system 506 to aid in managing the usage of wireless links in MLO mode. The link management system 506 includes program data 508 and program instructions 510 to manage the roaming of the client devices. The program instructions 510 may be example representatives of the link management instructions 112 of FIG. 1.

The program data 508 may store a variety of data that may be received, used, and/or generated by the processing resource 502 as the processing resource 502 executes the program instructions 510. In some examples, the program data 508 may store link configuration data, including information about the wireless links (e.g., the wireless links 106 and 108). This information may include, for each wireless link, one or more of a channel number, a frequency range, or a bandwidth. Further, the processing resource 502 may store values of the bandwidth difference between the wireless links 106 and 108 and respective occupancy metrics in the program data 508. Further, in some examples, the processing resource 502 may store values of the bandwidth thresholds (e.g., BTH1, BTH2, or BTH3) and values of the occupancy thresholds (e.g., OMTH1, OMTH2, or OMTH3) in the program data 508. In certain examples, the values of the bandwidth thresholds and the occupancy thresholds may be customizable, and the processing resource 502 may enable a user interface for a user (e.g., an administrator) of the networking device 500 to input and/or modify these values. In that case, the program data 508 may also store information that is useful for presenting the user interface on a display, for example.

In accordance with examples consistent with the present disclosure, the networking device 500 may execute the link management system 506, by way of the processing resource 502 executing the program instructions 510, to aid in managing the usage of wireless links in MLO mode. In particular, in some examples, the processing resource 502 may execute one or more of the program instructions 510 to perform the method steps described in conjunction with FIGS. 2-4. For example, the program instructions 510 may include instructions 512, 514, and 516.

In particular, the instructions 512, when executed by the processing resource 502, may cause the processing resource 502 to determine a bandwidth difference between a first wireless link and a second wireless link, wherein the first wireless link and the second wireless link are configured for MLO mode. Further, the instructions 514, when executed by the processing resource 502, may cause the processing resource 502 to determine a first occupancy metric for the first wireless link and a second occupancy metric for the second wireless link, wherein the first occupancy metric and the second occupancy metric respectively indicate a level of busyness of the first wireless link and the second wireless link. Moreover, the instructions 516, when executed by the processing resource 502, may cause the processing resource 502 to switch an operation of the networking device between the MLO mode and a limited wireless link operating mode based on the bandwidth difference, the first occupancy metric, and the second occupancy metric. In the limited wireless link operating mode, the network device is configured to stop communicating over the busier of the first wireless link and the second wireless link.

Although not shown, in some examples, the machine-readable storage medium 504 may be encoded with certain additional executable instructions to perform any other operations performed by the networking device 500, without limiting the scope of the present disclosure.

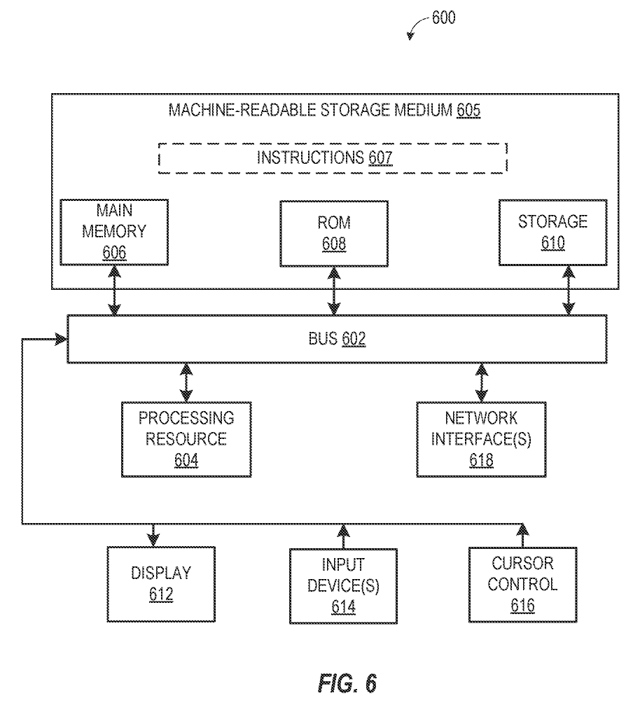

FIG. 6 depicts a block diagram of an example computing system 600 in which various examples described herein may be implemented. In some examples, the computing system 600 may be configured to operate as a wireless networking device, for example, the networking device 102 (e.g., an AP) of FIG. 1, capable of performing various operations described in one or more of the earlier drawings.

The computing system 600 may include a bus 602 or other communication mechanisms for communicating information, a hardware processor, also referred to as processing resource 604, and a machine-readable storage medium 605 coupled to the bus 602 for processing information. The processing resource 604 and the machine-readable storage medium 605 may be example representatives of the processing resource 502 and the machine-readable storage medium 504 of FIG. 5, certain details of which are not repeated herein for brevity.

In some examples, the machine-readable storage medium 605 may include a main memory 606, such as a RAM, cache, and/or other dynamic storage devices, coupled to the bus 602 for storing information and instructions to be executed by the processing resource 604. The main memory 606 may also be used for storing temporary variables or other intermediate information during the execution of instructions to be executed by the processing resource 604. Such instructions, when stored in storage media accessible to the processing resource 604, render the computing system 600 into a special-purpose machine that is customized to perform the operations specified in the instructions. The machine-readable storage medium 605 may further include a read-only memory (ROM) 608 or other static storage device coupled to the bus 602 for storing static information and instructions for the processing resource 604. Further, in the machine-readable storage medium 605, a storage device 610, such as a magnetic disk, optical disk, or USB thumb drive (Flash drive), etc., may be provided and coupled to the bus 602 for storing information and instructions.

Further, in some implementations, the computing system 600 may be coupled, via the bus 602, to a display 612, such as a liquid crystal display (LCD) (or touch-sensitive screen), for displaying information to a computer user. In some examples, an input device 614, including alphanumeric and other keys (physical or software-generated and displayed on a touch-sensitive screen), may be coupled to the bus 602 for communicating information and command selections to the processing resource 604. Also, in some examples, another type of user input device may be a cursor control 616, such as a mouse, a trackball, or cursor direction keys that may be connected to the bus 602. The cursor control 616 may communicate direction information and command selections to the processing resource 604 for controlling cursor movement on the display 612. In some other examples, the same direction information and command selections as cursor control may be implemented via receiving touches on a touchscreen without a cursor.

In some examples, the computing system 600 may include a user interface module to implement a GUI that may be stored in a mass storage device as executable software code that is executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 600 also includes a network interface 618 coupled to bus 602. The network interface 618 provides a two-way data communication coupling to one or more network links that are connected to one or more local networks. For example, the network interface 618 may be an integrated services digital network (ISDN) card, cable modem, satellite modem, or a modem to provide a data communication connection to a corresponding type of telephone line. As another example, the network interface 618 may be a local area network (LAN) card or a wireless communication unit (e.g., Wi-Fi chip/module).

In some examples, the machine-readable storage medium 605 (e.g., one or more of the main memory 606, the ROM 608, or the storage device 610) stores instructions 607 which when executed by the processing resource 604 may cause the processing resource 604 to execute one or more of the methods/operations described hereinabove. The instructions 607 may be stored on any of the main memory 606, the ROM 608, or the storage device 610. In some examples, the instructions 607 may be distributed across one or more of the main memory 606, the ROM 608, or the storage device 610. In some examples, when the computing system 600 is configured to operate as a networking device (e.g., the networking device 102 or 104 of FIG. 1), the instructions 607 may include instructions which when executed by the processing resource 604 may cause the processing resource 604 to perform one or more of the methods described in FIGS. 2-4.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, etc., may be used herein to describe various elements, these elements should not be limited by these terms, as these terms are only used to distinguish one element from another unless stated otherwise or the context indicates otherwise.

What is claimed is:

1. A method for managing usage of wireless links for a networking device operating in a Multi-Link Operation (MLO) mode over a first wireless link and a second wireless link, the method comprising:
determining, by the networking device, a bandwidth difference between the first wireless link and the second wireless link;
determining, by the networking device, a first occupancy metric for the first wireless link and a second occupancy metric for the second wireless link, wherein the first occupancy metric and the second occupancy metric respectively indicate a level of busyness of the first wireless link and the second wireless link; and
switching, by the networking device, an operation of the networking device between the MLO mode and a limited wireless link operating mode based on the bandwidth difference, the first occupancy metric, and the second occupancy metric, wherein, in the limited wireless link operating mode, the network device is configured to stop communicating over a busier one of the first wireless link and the second wireless link.

2. The method of claim 1, wherein the first occupancy metric and the second occupancy metric are measures of a retry percentage, a wireless link busy percentage, or a combination thereof.

3. The method of claim 1, wherein the first wireless link has a higher bandwidth than the second wireless link.

4. The method of claim 1, further comprising determining, by the networking device, that the bandwidth difference exceeds a first bandwidth threshold.

5. The method of claim 4, wherein switching the operation of the networking device comprises maintaining the operation of the networking device in the MLO mode in response to determining that the first occupancy metric exceeds a first occupancy threshold and the second occupancy metric does not exceed the first occupancy threshold.

6. The method of claim 4, wherein switching the operation of the networking device comprises configuring the networking device in the limited wireless link operating mode allowing both transmission and reception via the first wireless link in response to determining that: (i) the second occupancy metric exceeds a first occupancy threshold, or (ii) both the first occupancy metric and the second occupancy metric do not exceed the first occupancy threshold.

7. The method of claim 4, further comprising determining, by the networking device, that the bandwidth difference exceeds a second bandwidth threshold smaller than the first bandwidth threshold.

8. The method of claim 7, wherein switching the operation of the networking device comprises maintaining the operation of the networking device in the MLO mode in response to determining that the first occupancy metric exceeds a second occupancy threshold and the second occupancy metric does not exceed the second occupancy threshold.

9. The method of claim 7, wherein switching the operation of the networking device comprises configuring the networking device in the limited wireless link operating mode allowing both transmission and reception via the first wireless link in response to determining that: (i) the second occupancy metric exceeds a second occupancy threshold, or (ii) both the first occupancy metric and the second occupancy metric do not exceed the second occupancy threshold.

10. A networking device comprising:
a non-transitory machine-readable storage medium storing executable instructions;
a processing resource coupled to the non-transitory machine-readable storage medium and configured to execute one or more of the instructions to:
determine a bandwidth difference between a first wireless link and a second wireless link, wherein the first wireless link and the second wireless link are configured for a Multi-Link Operation (MLO) mode:
determine a first occupancy metric for the first wireless link and a second occupancy metric for the second wireless link, wherein the first occupancy metric and the second occupancy metric respectively indicate a level of busyness of the first wireless link and the second wireless link; and
switch an operation of the networking device between the MLO mode and a limited wireless link operating mode based on the bandwidth difference, the first occupancy metric, and the second occupancy metric, wherein, in the limited wireless link operating mode, the network device is configured to stop communicating over a busier one of the first wireless link and the second wireless link.

11. The networking device of claim 10, wherein the first occupancy metric and the second occupancy metric are measures of a retry percentage, a wireless link busy percentage, or a combination thereof.

12. The networking device of claim 10, wherein the processing resource is configured to execute one or more of the instructions to determine that the bandwidth difference exceeds a first bandwidth threshold.

13. The networking device of claim 10, wherein the processing resource is configured to execute one or more of the instructions to:
maintain the operation of the networking device in the MLO mode in response to determining that the first occupancy metric exceeds a first occupancy threshold and the second occupancy metric is smaller than the first occupancy threshold; or
configure the networking device in the limited wireless link operating mode allowing both transmission and reception via the first wireless link in response to determining that: (i) the second occupancy metric exceeds a first occupancy threshold, or (ii) both the first occupancy metric and the second occupancy metric do not exceed the first occupancy threshold.

14. The networking device of claim 12, wherein the processing resource is configured to execute one or more of the instructions to determine that the bandwidth difference exceeds a second bandwidth threshold smaller than the first bandwidth threshold.

15. The networking device of claim 14, wherein the processing resource is configured to execute one or more of the instructions to maintain the operation of the networking device in the MLO mode in response to determining that the first occupancy metric exceeds a second occupancy threshold and the second occupancy metric does not exceed the second occupancy threshold.

16. The networking device of claim 14, wherein the processing resource is configured to execute one or more of the instructions to configure the networking device in the limited wireless link operating mode allowing both transmission and reception via the first wireless link in response to determining that: (i) the second occupancy metric exceeds a second occupancy threshold, or (ii) both the first occupancy metric and the second occupancy metric do not exceed the second occupancy threshold.

17. A method for managing usage of wireless links for a networking device operating in a Multi-Link Operation (MLO) mode over a first wireless link and a second wireless link, the method comprising:
determining, by the networking device, a bandwidth difference between the first wireless link and the second wireless link;
determining, by the networking device, a first occupancy metric for the first wireless link and a second occupancy metric for the second wireless link, wherein the first occupancy metric and the second occupancy metric respectively indicate a level of busyness of the first wireless link and the second wireless link; and
configuring the networking device in a limited wireless link operating mode allowing both transmission and reception via the first wireless link in response to determining that: (i) the bandwidth difference exceeds a first bandwidth threshold and the second occupancy metric exceeds a first occupancy threshold, or (ii) the bandwidth difference exceeds the first bandwidth threshold and both the first occupancy metric and the second occupancy metric do not exceed the first occupancy threshold.

18. The method of claim 17, further comprising maintaining the operation of the networking device in the MLO mode in response to determining that the first occupancy metric exceeds a first occupancy threshold and the second occupancy metric does not exceed the first occupancy threshold.

19. The method of claim 17, further comprising:
determining, by the networking device, that the bandwidth difference exceeds a second bandwidth threshold smaller than the first bandwidth threshold; and
maintaining the operation of the networking device in the MLO mode in response to determining that the first occupancy metric exceeds a second occupancy threshold and the second occupancy metric does not exceed the second occupancy threshold.

20. The method of claim 17, further comprising:
determining, by the networking device, that the bandwidth difference exceeds a second bandwidth threshold smaller than the first bandwidth threshold; and
configuring the networking device in the limited wireless link operating mode allowing both transmission and reception via the first wireless link in response to determining that: (i) the second occupancy metric exceeds a second occupancy threshold, or (ii) both the first occupancy metric and the second occupancy metric do not exceed the second occupancy threshold.
